(19) United States
(12) Patent Application Publication
(10) Pub. No.: US 2026/0312467 A1
(43) Pub. Date: Oct. 8, 2026

(54) MOTOR

(71) Applicant: MINEBEA MITSUMI Inc., Kitasaku-gun, Nagano (JP)

(72) Inventor: Masashi HAYASHIBARA, Kitasaku-gun, Nagano (JP)

(21) Appl. No.: 19/481,662

(22) PCT Filed: Apr. 25, 2024
(86) PCT No.: PCT/JP2024/016224

§ 371 Date: Nov. 5, 2025

(30) Foreign Application Priority Data
May 15, 2023 (JP) 2023-079887

(51) Int. Cl. H02K 11/215; H02K 1/14; H02K 1/276

(52) U.S. Cl. CPC H02K 11/215; H02K 1/146; H02K 1/276

(57) ABSTRACT

A motor includes: a stator including an energized phase, a phase energized more weakly than the energized phase or a non-energized phase at a predetermined electric angle; and a magnetic sensor. The magnetic sensor is arranged to be opposed to the phase energized more weakly or the non-energized phase.

### TECHNICAL FIELD

The present invention relates to a motor.

### BACKGROUND ART

In a motor, it is known to use a magnetic sensor to detect the magnetic pole position of a rotor (e.g., PTL 1). A typical magnetic sensor switches the output signal upon detecting a magnetic flux density exceeding (or falling below) a predetermined operating point, for example. However, since a stator provided with a coil is present near the magnetic sensor, an error may occur in the detection angle of the magnetic sensor due to the influence of the magnetic field generated by the stator under high-load (high-current) conditions, for example.

### CITATION LIST

### Patent Literature

PTL 1: Japanese Unexamined Utility Model Application Publication No.62-149271

### SUMMARY OF INVENTION

### Technical Problem

An example of an object of the present invention is to provide a motor that can reduce detection angle errors under high-load conditions.

### Solution to Problem

A motor according to the present invention includes: a stator including an energized phase, a phase energized more weakly than the energized phase or a non-energized phase at a predetermined electric angle; and a magnetic sensor. The magnetic sensor is arranged to be opposed to the phase energized more weakly or the non-energized phase.

### BRIEF DESCRIPTION OF DRAWINGS

FIG. 1 is a perspective view of a motor according to an embodiment as an example of the present invention.

FIG. 2 is a sectional view, taken along a rotation axis, of the motor according to the embodiment as an example of the present invention.

FIG. 3 is a sectional view, taken along a radial direction, of the motor according to the embodiment as an example of the present invention.

FIG. 4 is a schematic view illustrating an example of aspects of the wiring configuration of the motor according to the embodiment as an example of the present invention.

FIG. 5 is a perspective view of a motor according to another embodiment as an example of the present invention.

FIG. 6 is a perspective view of a motor according to still another embodiment as an example of the present invention.

### DESCRIPTION OF EMBODIMENTS

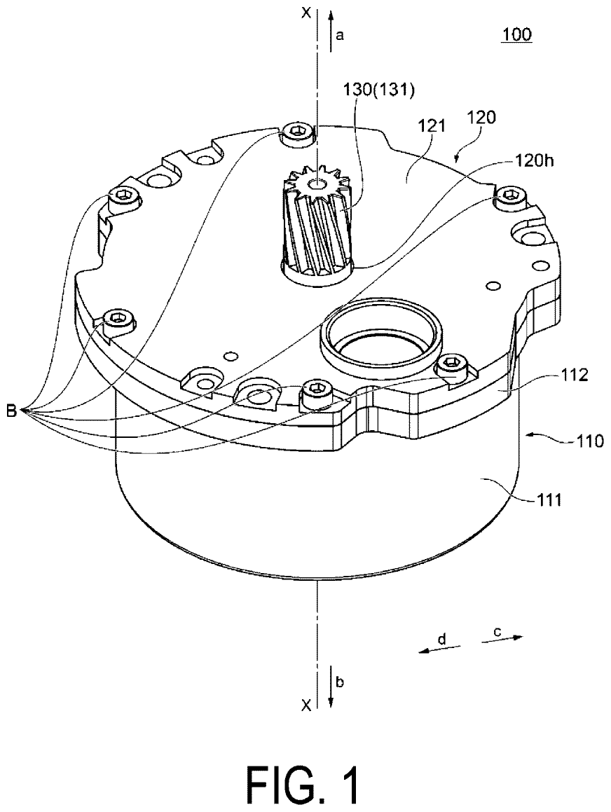

In the description of the embodiments of the present invention, a direction (rotation axis direction) along a rotation axis X of the rotor is referred to simply as the axis direction, for convenience of description. In the axis direction, an arrow a direction in FIGS. 1, 2, 5, and 6 is referred to as one side, and an arrow b direction opposite to the one side is referred to as the other side. In a plane orthogonal to the rotation axis X, the direction approaching or away from the rotation axis X is referred to as the radial direction. In the radial direction, an arrow c direction away from the rotation axis X is referred to as outside or one side, and an arrow d direction approaching the rotation axis X is referred to as inside or the other side. The rotation direction around the rotation axis X is referred to as the circumferential direction.

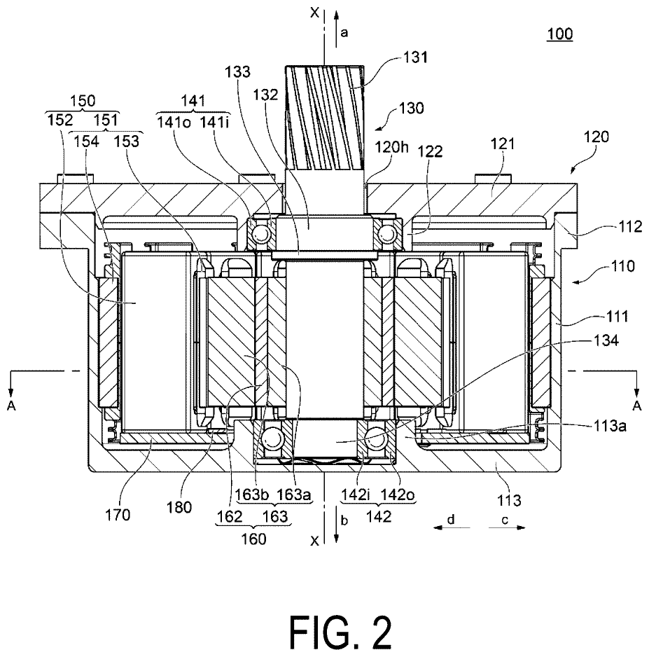

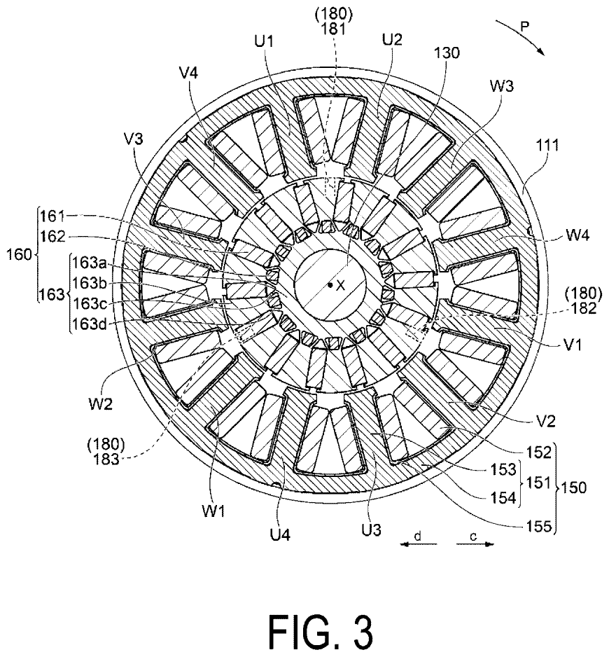

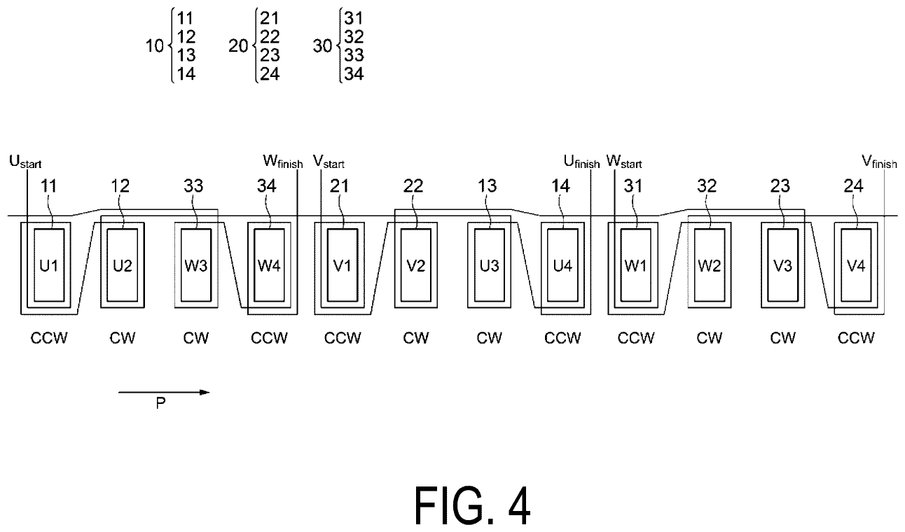

An embodiment being one example of the present invention will be described below with reference to the drawings. FIG. 1 is a perspective view of a motor 100 according to the present embodiment. FIG. 2 is a sectional view taken along the rotation axis X of the motor 100. It should be noted that in FIG. 2, a shaft 130 is not illustrated as a cross section. FIG. 3 is a sectional view taken along the radial direction of the motor 100, and is an A-A cross sectional view in FIG. 2 (as viewed from the one side (the arrow a direction) in the axis direction toward the other side (the arrow b direction)). FIG. 4 is a schematic view illustrating an aspect of the wiring of the motor 100.

As illustrated in FIG. 1, the motor 100 includes a housing 110, a cover 120, and a shaft 130, and has a substantially cylindrical shape as a whole. The housing 110 includes a housing body 111 having a substantially cylindrical shape, a flange part 112 extending from an end part at one side (the arrow a direction) in the axis direction to one side (the arrow c direction) in the radial direction, and a bottom part 113 that closes the other side (the arrow b direction) of the housing body 111 in the axis direction (see FIG. 2). The cover 120 includes a plate part 121 having a substantially disk shape, and the plate part 121 has an external shape corresponding to the external shape (the shape of the outer edge part in the radial direction) of the flange part 112 of the housing 110. The edge part of the plate part 121 of the cover 120 is connected to the flange part 112 of the housing 110 by a plurality of (in FIG. 1, six) bolts B inserted in the axis direction.

In the radial direction, at the center part of the cover 120, a circular hole 120h is formed coaxially with the housing body 111. The hole 120h extends in the axis direction through the plate part 121 of the cover 120. As illustrated in FIG. 2, at one side (the arrow c direction) of the hole 120h of the cover 120 in the radial direction, a cylindrical protruding part 122 protruding to the other side (the arrow b direction) in the axis direction is provided coaxially with the circular hole 120h. The protruding part 122 holds a first bearing 141 described later.

As illustrated in FIG. 2, the shaft 130 is a member with a substantially columnar shape, and extends in the axis direction to one side (the arrow a direction) beyond the cover 120 from the vicinity of the bottom part 113 of the housing 110. The shaft 130 protrudes to one side (the arrow a direction) in the axis direction through the hole 120h of the cover 120.

The shaft 130 includes one end part 131 at one side (the arrow a direction) in the axis direction, and the other end part 134 at the other side (the arrow b direction). At an outer peripheral surface of the one end part 131 of the shaft 130 (the surface at one side (the arrow c direction) in the radial direction), a helical gear is formed so as to enable power extraction. It should be noted that the gear may not be formed at the one end part 131 of the shaft 130. The other end part 134 of the shaft 130 has an outer diameter (the size at one side (the arrow c direction) in the radial direction) slightly smaller than the other parts.

In addition, the shaft 130 includes a circular part 132 having an outer diameter (the size at one side (the arrow c direction) in the radial direction) larger than the other parts and located slightly to one side (the arrow a direction) of the center part in the axis direction. In the axis direction, a circular part (second circular part) 133 having a still larger outer diameter than the circular part 132 is connected to the other side (the arrow b direction) of the circular part (first circular part) 132 of the shaft 130.

In the radial direction, the first bearing 141 is arranged at one side (the arrow c direction) of the circular part 132 of the shaft 130. The first bearing 141 is a ball bearing including an inner ring 141i, an outer ring 1410 and a rolling body. Note that the first bearing 141 is not limited to ball bearings, and may be other various bearings such as sleeve bearings, for example. In addition, the first bearing 141 may be a ball bearing with another configuration including an outer ring and a rolling body fitted in a recess of the outer peripheral surface of the shaft (the surface at the outside (the arrow c direction) in the radial direction).

The inner ring 141i of the first bearing 141 is bonded to or press-fitted into the outer peripheral surface of the circular part 132 of the shaft 130 (the surface at one side (the arrow c direction) in the radial direction). In this manner, the inner ring 141i of the first bearing 141 is fixed to the shaft 130, and rotates integrally with the shaft 130 around the rotation axis X. In addition, in the axis direction, the inner ring 141i of the first bearing 141 is in contact with the surface of the circular part 133 of the shaft 130 at the one side (the arrow a direction), from the one side (the arrow a direction). In this manner, the shaft 130 is positioned in the axis direction. The outer ring 1410 of the first bearing 141 is bonded to or press-fitted into the inner peripheral surface (the surface at the other side (the arrow d direction) in the radial direction) of the protruding part 122 of the cover 120. In this manner, the outer ring 1410 of the first bearing 141 is held at the protruding part 122 of the cover 120. With the above-mentioned configuration, the first bearing 141 rotatably supports the shaft 130 with respect to the cover 120.

A second bearing 142 is arranged at one side (the arrow c direction) of the other end part 134 of the shaft 130 in the radial direction. The second bearing 142 is a ball bearing including an inner ring 142i, an outer ring 1420 and a rolling body. Note that the second bearing 142 is not limited to ball bearings, and may be other various bearings such as sleeve bearings, for example. In addition, the second bearing 142 may be a ball bearing with another configuration including an outer ring and a rolling body fitted in a recess of the outer peripheral surface of the shaft (the surface at the outside (the arrow c direction) in the radial direction).

The inner ring 142i of the second bearing 142 is bonded to or press-fitted into the outer peripheral surface (the surface at one side (the arrow c direction) in the radial direction) of the other end part 134 of the shaft 130. In this manner, the inner ring 142i of the second bearing 142 is fixed to the shaft 130, and rotates integrally with the shaft 130 around the rotation axis X. A cylindrical holding part 113a protruding to one side (the arrow a direction) in the axis direction is provided at the center part of the bottom part 113 of the housing 110. The outer ring 1420 of the second bearing 142 is bonded to or press-fitted into the inner peripheral surface (the surface at the other side (the arrow d direction) in the radial direction) of the holding part 113a of the housing 110. In this manner, the outer ring 1420 of the second bearing 142 is held at the holding part 113a of the housing 110. With the above-mentioned configuration, the second bearing 142 rotatably supports the shaft 130 with respect to the housing 110.

As illustrated in FIG. 2, in the axis direction, a rotor 160 is arranged between the other end part 134 and the circular part 132 of the shaft 130. The inner peripheral surface (the surface at the other side (the arrow d direction) in the radial direction) of an annular part 163a (described below) of the rotor 160 is fixed to the outer peripheral surface (the surface at one side (the arrow c direction) in the radial direction) of the shaft 130. Accordingly, the shaft 130 is rotatable integrally with the rotor 160.

As illustrated in FIG. 3, the rotor 160 includes a plurality of first magnets 161, a plurality of second magnets 162, and a rotor core (magnetic body) 163. The rotor core 163 includes the annular part 163a, and a plurality of (in FIG. 3, fourteen) magnetic pole pieces 163b radially extending from the annular part 163a through a pair of coupling parts 163c and 163d. A plurality of magnets are arranged inside the rotor core 163. More specifically, the first magnet 161 is arranged in each of substantially rectangular spaces between the magnetic pole pieces 163b adjacent to each other in the circumferential direction, and the second magnet 162 is arranged in each of substantially trapezoidal spaces between the pair of coupling parts 163c and 163d. In the circumferential direction, the first magnet 161 is in contact with the side surfaces of both of the adjacent two magnetic pole pieces 163b, and in the radial direction, the second magnet 162 is in contact with the outer peripheral surface of the annular part 163a and the inner peripheral surface of the magnetic pole piece 163b.

Focusing on one magnetic pole piece 163b, the magnetic pole of one first magnet 161 at one surface side of the side surfaces of the magnetic pole piece 163b in the circumferential direction, the magnetic pole of the other first magnet 161 at the other surface side, and the magnetic pole of the second magnet 162 at the inner peripheral surface side of the magnetic pole piece 163b are the same magnetic pole. A magnetic force of N-pole or S-pole is applied to each magnetic pole piece 163b, thus forming a single magnetic flux emitted radially outward (the arrow c direction). The magnetic pole of the magnetic pole piece 163b is configured to alternately repeat N-pole and S-pole in the circumferential direction.

At the other side (the arrow d direction) of the housing body 111 of the housing 110 in the radial direction, a stator 150 is supported to be opposed to the rotor 160 in the radial direction. The stator 150 is arranged at one side (the arrow c direction) in the radial direction of the rotor 160, so as to surround the rotor 160 from the one side (the arrow c direction) in the radial direction.

As illustrated in FIG. 3, the stator 150 includes a stator core (magnetic body) 151 and a coil 152. The stator core 151 is a laminated body formed by silicon steel sheets or the like stacked in the axis direction, and includes an annular part 154 arranged coaxial with the shaft 130, and a plurality of (in FIG. 3, twelve) teeth (magnetic pole part) 153 formed to extend from the annular part 154 toward the shaft 130. The teeth 153 are opposed to the rotor 160. The coil 152 is wound around each of the plurality of teeth 153. The stator core 151 and the coil 152 are insulated by an insulator 155 formed of an insulating member.

In the following description, for convenience, among the plurality of teeth 153 of the stator 150, a given tooth is referred to as the first tooth, and the tooth adjacent to the first tooth in a first direction (in FIG. 3, the clockwise direction) P in the circumferential direction is referred to as the second tooth, and, the tooth number increases toward the first direction P. Among the plurality of teeth 153 of the stator 150, the first tooth is referred to as U1, the second tooth as U2, the third tooth as W3, the fourth tooth as W4, the fifth tooth as V1, the sixth tooth as V2, the seventh tooth as U3, the eighth tooth as U4, the ninth tooth as W1, the tenth tooth as W2, the eleventh tooth as V3, and the twelfth tooth as V4. In the stator 150, the tooth adjacent to V4 in the first direction P is U1.

FIG. 4 is a schematic view of the stator 150 developed in a plane as viewed from the other side in the radial direction (inside, the arrow d direction). A first coil group 10 that forms the first phase (U phase) is wound around U1, U2, U3, and U4 among the plurality of teeth 153 of the stator 150. The coils wound around U1, U2, U3, and U4 are referred to as a coil 11, a coil 12, a coil 13, and a coil 14, respectively. A second coil group 20 that forms the second phase (V phase) is wound around V1, V2, V3, and V4 among the plurality of teeth 153 of the stator 150. The coils wound around V1, V2, V3, and V4 are referred to as a coil 21, a coil 22, a coil 23, and a coil 24, respectively. A third coil group 30 that forms the third phase (W phase) is wound around W1, W2, W3, and W4 among the plurality of teeth 153 of the stator 150. The coils wound around W1, W2, W3, and W4 are referred to as a coil 31, a coil 32, a coil 33, and a coil 34, respectively.

The first coil group 10 is formed as follows. First, in the vicinity of U1, winding is started from a winding start part U start, and the coil 11 is formed by winding the electric wire counterclockwise (CCW) around U1. Note that as used herein, “clockwise (CW)” and “counterclockwise (CCW)” mean the winding direction as viewed from the other side (inside, the arrow d direction) in the radial direction. Next, the coil 12 is formed by winding the electric wire clockwise (CW) around U2. Next, while forming a crossover wire, the coil 13 is formed by winding the electric wire clockwise (CW) around U3. Finally, the coil 14 is formed by winding the electric wire counterclockwise (CCW) around the U4, thus the electric wire reaches a winding end part U finish.

The second coil group 20 is formed as follows. First, in the vicinity of V1, winding is started from a winding start part V start, and the coil 21 is formed by winding the electric wire counterclockwise (CCW) around V1. Next, the coil 22 is formed by winding the electric wire clockwise (CW) around V2. Next, while forming a crossover wire, the coil 23 is formed by winding the electric wire clockwise (CW) around V3. Finally, the coil 24 is formed by winding the electric wire counterclockwise (CCW) around V4, thus the electric wire reaches a winding end part V finish.

The third coil group 30 is formed as follows. First, in the vicinity of W1, winding is started from a winding start part W start, and the coil 31 is formed by winding the electric wire counterclockwise (CCW) around W1. Next, the coil 32 is formed by winding the electric wire clockwise (CW) around W2. Next, while forming a crossover wire, the coil 33 is formed by winding the electric wire clockwise (CW) around W3. Finally, a coil 44 is formed by winding the electric wire counterclockwise (CCW) around W4, thus the electric wire reaches a winding end part W finish.

When forming each of the coils of the first coil group 10 to the third coil group 30 as described above, the coils are formed by winding the electric wire at the respective teeth 153 in a spiral form from the other side (inside, the arrow d direction) toward the one side (outside, the arrow c direction), or in the opposite direction in the radial direction. The number of turns of the coil my be any number.

Depending on the number of turns, the coil of the first layer may be formed from the other side (inside, the arrow d direction) toward the one side (outside, the arrow c direction) in the radial direction, and then the coil of the second layer may be formed from the one side (outside, the arrow c direction) toward the other side (inside, the arrow d direction) in the radial direction, for example. The number of layers may be any number. In the case where the coil is formed in a plurality of layers, the layer (inner layer) at the side closer to the teeth 153 is the winding start side, and the layer (outer layer) at the side remote from the teeth 153 is the winding end side. As such, regarding the two coils connected by the crossover wire, the coil with the outer layer connected with the crossover wire can be identified as the coil at the winding start side, and the coil with the inner layer connected with the crossover wire can be identified as the coil at the winding end side.

In addition, in the case where a certain coil is formed by winding from the other side (inside, the arrow d direction) toward the one side (outside, the arrow c direction) in the radial direction, the coil to be formed next may be formed by winding from the one side (outside, the arrow c direction) toward the other side (inside, the arrow d direction) in the radial direction. In this case, a plurality of crossover wires sequentially formed in the circumferential direction may be alternately arranged at the other side (inside, the arrow d direction) and the one side (outside, the arrow c direction) in the radial direction, or may be arranged with the winding start side always located at either the other side (inside, the arrow d direction) or the one side (outside, the arrow c direction) in the radial direction.

The mutual electrical connection among the first coil group 10 to the third coil group 30 may be achieved by connecting the conductive wires each other, or may be achieved through a substrate 170 described below. In addition, the electrical connection among the coils belonging to the same phase (same coil group) may be achieved by means of the crossover wire as described above, or may be achieved through the substrate 170 described below. By achieving one or both of the mutual electrical connection among the first coil group 10 to the third coil group 30, and the electrical connection among the coils belonging to the same phase (same coil group) through the substrate 170, the crossover wire can be omitted, and the size of the motor 100 can be reduced.

As illustrated in FIG. 2, in the axis direction, the substrate 170 with an annular shape is arranged at the other side (the arrow b direction) of the stator 150. The substrate 170 is a plate-shaped insulating member. A print wiring circuit not illustrated in the drawing is formed at the substrate 170. The substrate 170 is fixed to the insulator 155 of the stator 150 directly or through an adapter not illustrated in the drawing, for example.

A plurality of (in the present embodiment, three) magnetic sensors 180 (magnetic sensors 181, 182 and 183) for detecting the magnetic pole position (rotation angle) of the rotor 160 is arranged at the surface (the surface at the side closer to the rotor 160) of the substrate 170 at one side (the arrow a direction) in the axis direction. In the axis direction, the magnetic sensor 180 is opposed to the rotor 160. In the present embodiment, the magnetic sensor 180 is a Hall IC, and is surface-mounted at the substrate 170 and electrically connected to the circuit of the substrate 170. In the present embodiment, the magnetic sensor 180 is a zero-cross detection type Hall IC that switches the output signal upon detecting a change in magnetic pole of the rotor 160 (switching from S-pole to N-pole, or from N-pole to S-pole). It should be noted that the magnetic sensor 180 may be another type of Hall IC, or may be a magnetic sensor other than a Hall IC.

In the motor 100 of 14 poles and 12 slots, the teeth 153 are arranged at intervals of 30° in the circumferential direction. At a predetermined current phase (electric angle), the first coil group 10 to the third coil group 30 of the stator 150 are classified into an energized and excited phase (energized phase or excited phase), a phase energized more weakly and excited more weakly than the energized phase (weakly energized phase or weakly excited phase) or a phase not energized and not excited (non-energized phase or non-excited phase). In the following description, at a predetermined current phase, the coil wound around the teeth 153 of the energized phase is referred to also as the first coil, and the coil wound around the weakly energized phase or non-energized phase is referred to also as the second coil. In the radial direction, a predetermined magnetic pole of the rotor 160 is opposed to the teeth 153 of the energized phase. Sequential switching of the energized phase, the weakly energized phase and the non-energized phase rotates the rotor 160 due to electromagnetic interaction between the stator 150 and the rotor 160.

The “weakly energized phase” may be a phase energized with a current of 50% or less of the maximum amplitude, a phase energized with a current of 40% or less of the maximum amplitude, a phase energized with a current of 30% or less of the maximum amplitude, a phase energized with a current of 20% or less of the maximum amplitude, or a phase energized with a current of 10% or less of the maximum amplitude, for example.

The magnetic sensor 180 is arranged to be opposed to the weakly energized phase or the non-energized phase at a predetermined current phase. Here, the state where the magnetic sensor 180 is arranged to be opposed to the weakly energized phase or non-energized phase” means that the magnetic sensor 180 is arranged at a position (angle) corresponding to the tooth 153 of the weakly energized phase or the non-energized phase in the circumferential direction. In the case where the teeth 153 of the weakly energized phase or the non-energized phase are continuously arranged in the circumferential direction, the magnetic sensor 180 may be arranged at any position (angle) between the adjacent teeth 153. In other words, in the circumferential direction, the magnetic sensor 180 is arranged at a position (angle) overlapping the second coil or a position (angle) between adjacent two second coils among a plurality of the second coils.

In the circumferential direction, the magnetic sensor 180 may be arranged within a range of −15° to 15°, within a range of −10°to 10°, within a range of −5°to 5°, or at the position (angle) of 0° with respect to the position (angle) of the teeth 153 making up the weakly energized phase or the non-energized phase (or, in the case where the teeth 153 making up the weakly energized phase or the non-energized phase are continuously provided, with respect to the center position (angle) between the adjacent teeth 153).

In the motor 100 according to the present embodiment, control to set the counter-electromotive voltage and the current to be in-phase (so-called “Id=0 control”) is performed. Assuming 0° as the current phase (electric angle) at the zero-crossing point of the counter-electromotive voltage of the U phase, the U phase becomes the non-energized phase when the current phase is 0° and 180°, the V phase becomes the non-energized phase when the current phase is 120° and 300°, and the W phase becomes the non-energized phase when the current phase is 240° and 60°. Accordingly, when the current phase is 0° and 180°, the coils belonging to the V phase and the W phase (the coils 21, 22, 23, 24, 31, 32, 33, and 34) are the first coil, and the coils belonging to the U phase (the coils 11, 12, 13, and 14) are the second coil. When the current phase is 120° and 300°, the coils belonging to the U phase and the W phase (the coils 11, 12, 13, 14, 31, 32, 33, and 34) are the first coil, and the coils belonging to the V phase (the coils 21, 22, 23, 24) are the second coil. When the current phase is 240° and 60°, the coils belonging to the U phase and the V phase (the coils 11, 12, 13, 14, 21, 22, 23, and 24) are the first coil, and the coils belonging to the W phase (the coils 31, 32, 33, and 34) are the second coil.

In the case where there are a plurality of magnetic sensors 180, each of the magnetic sensors 180 is arranged to be opposed to the weakly energized phase or the non-energized phase at each of different current phases. In the motor 100 according to the present embodiment, a magnetic sensor 181, among the plurality of magnetic sensors 180, is arranged at a position (angle) at a machine angle of 15° in the first direction P from U1 (a position (angle) between U1 and U2) (FIG. 3). Specifically, the magnetic sensor 181 corresponding to the U phase is arranged between the adjacent coils 11 and 12 among the second coils when the current phase is 0° and 180°. A magnetic sensor 182, among the plurality of magnetic sensors 180, is arranged at a position (angle) at a machine angle of 15° in the first direction P from V1 (a position (angle) between V1 and V2). Specifically, the magnetic sensor 182 corresponding to the V phase is arranged between the adjacent coils 21 and 22 among the second coils when the current phase is 120° and 300°. A magnetic sensor 183, among the plurality of magnetic sensors 180, is arranged at a position (angle) at a machine angle of 15° in the first direction P from W1 (a position (angle) between W1 and W2). Specifically, the magnetic sensor 183 corresponding to the W phase is arranged between the adjacent coils 31 and 32 among the second coils when the current phase is 240° and 60°. Note that the magnetic sensor 181 may be arranged between U3 and U4, the magnetic sensor 182 may be arranged between V3 and V4, and the magnetic sensor 183 may be arranged between W3 and W4.

In the configuration of the motor 100 according to the present embodiment, the zero-crossing point of the counter-electromotive voltage of the U phase (the sign reversal point) is shifted by an electric angle of 15° from the magnetic pole angle of the rotor 160. In view of this, assuming 0° as the magnetic pole angle of the rotor 160 when U1 and the N-pole of the rotor 160 are opposed to each other, when the current phase is 0°, the zero-cross of the magnetic pole of the rotor 160 (switching of the magnetic pole) can be obtained at a position at an electric angle of 105° from U1 or U3 (at a position of a machine angle of 15° from the first direction P). In the motor 100, the magnetic sensor 181 as a zero-cross detection type Hall IC is arranged at a position (angle) at a machine angle of 15° in the first direction P from U1. In this manner, when the magnetic sensor 181 detects a change in magnetic pole of the rotor 160, the phase located in the vicinity (e.g., the phase closest to the magnetic sensor 181, in the present embodiment, the U phase) is the non-energized phase, and thus the magnetic sensor 181 is less susceptible to the influence (disturbance) of the magnetic field generated by the stator 150. The same applies to the V phase and W phase. When the magnetic sensor 182 detects a change in magnetic pole of the rotor 160, the phase located in the vicinity (e.g., the phase closest to the magnetic sensor 182, in the present embodiment, the V phase) is the non-energized phase, and when the magnetic sensor 183 detects a change in magnetic pole of the rotor 160, the phase located in the vicinity (e.g., the phase closest to the magnetic sensor 183, in the present embodiment, the W phase) is the non-energized phase, and thus, the magnetic sensors 182 and 183 are less susceptible to the influence (disturbance) of the magnetic field generated by the stator 150. In the above-described manner, with the motor 100 according to the present embodiment, detection angle errors are reduced even under high-load (high-current) conditions.

In the motor 100, if the substrate 170 is fixed to the housing 110, it is necessary to perform positioning between the housing 110 and the stator 150, and positioning between the substrate 170 and the housing 110 in order to install the magnetic sensor 180 in the above-described manner. In addition, if the substrate 170 is fixed to the cover 120, it is necessary to perform positioning between the housing 110 and the stator 150, positioning between the housing 110 and the cover 120, and positioning between the cover 120 and the substrate 170. In the motor 100 according to the present embodiment, since the substrate 170 having the magnetic sensor 180 mounted is fixed to the stator 150, only positioning between the stator 150 and the substrate 170 is required in order to install the magnetic sensor 180 in the above-described manner. Accordingly, the motor 100 according to the present embodiment is advantageous in terms of manufacturing cost.

In the motor 100 according to the present embodiment, one or both of the mutual electrical connection among the first coil group 10 to the third coil group 30, and the electrical connection among the coils belonging to the same phase (same coil group) can be performed through circuits and wiring formed at the substrate 170. In this manner, according to the motor 100 according to the present embodiment, the space for wiring can be reduced, and the size (thickness) of the motor can be reduced.

As described above, the motor according to the present invention has been described with reference to preferred embodiments, but the motor according to the present invention is not limited to the configurations of the embodiments described above. The motor according to the present invention may be of an inner rotor type or an outer rotor type. The motor according to the present invention may be a three-phase AC motor, another type of AC motor, or a DC motor.

The motor 100 according to the present embodiment has a configuration of so-called 14 poles and 12 slots with the rotor 160 having fourteen magnetic poles and the stator 150 having twelve teeth 153, but in the motor of the present invention, the number of poles of the rotor and the number of slots of the stator may be any numbers. In addition, in the motor 100 according to the present embodiment, a magnet is arranged inside the rotor core 163, but, the configuration of the rotor in the motor of the present invention is not limited to this. For example, some or all of magnets may be arranged at the outside of the rotor core.

In the motor 100 according to the present embodiment, the magnetic sensor 180 is arranged at the inner side of the inner peripheral part of the stator 150 in the radial direction and arranged to be opposed to the rotor 160 in the axis direction (axial arrangement); however, in the motor of the present invention, the magnetic sensor may be arranged at the stator 150 side of the outer periphery part of the rotor 160 in the radial direction and arranged to be opposed to the stator 150 in the axis direction (radial arrangement). In the motor of the present invention, the magnetic sensor is less susceptible to the influence of the magnetic field generated from the stator, and thus the magnetic sensor can be arranged at the stator side of the outer periphery part of the rotor in the radial direction and arranged to be opposed to the stator in the axis direction.

While the substrate 170 is fixed to the stator 150 in the motor 100 according to the present embodiment, the substrate and the stator may be integrally formed in the motor of the present invention. An embodiment including a substrate and a stator integrally formed is described below.

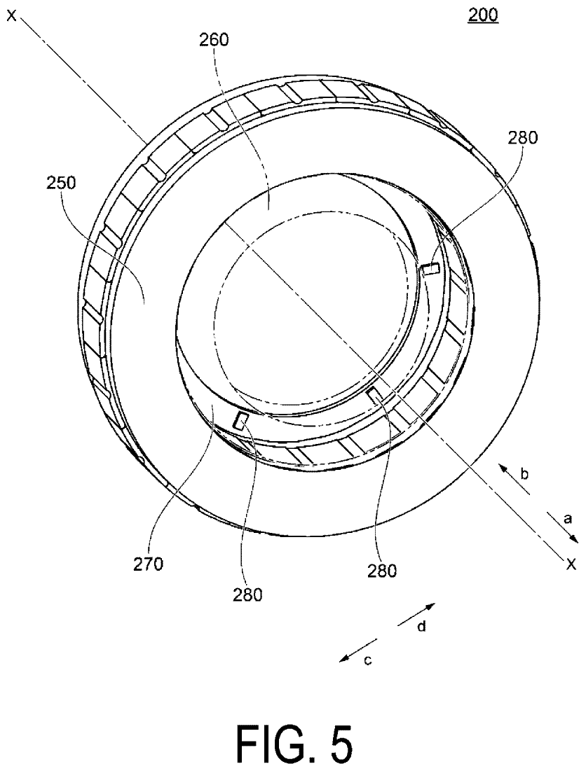

A motor 200 according to an embodiment illustrated in FIG. 5 includes a stator 250, a rotor 260 indicated by the virtual line, a substrate 270, and a magnetic sensor 280. In FIG. 5, the configurations other than the stator 250, the rotor 260, the substrate 270, and the magnetic sensor 280 in the motor 200 are omitted. The configurations of the omitted parts may be the same as or different from the configurations in the motor 100.

In the radial direction, at the inside of the stator 250 (the other side, the arrow d direction), the rotor 260 is coaxially arranged to be opposed to the stator 250. The stator 250 and the rotor 260 have substantially the same configurations as the stator 150 and the rotor 160 of the motor 100 except for the number of poles and slots.

In the motor 200, the stator 250 and the substrate 270 are integrally formed. More specifically, the insulator of the stator 250 and the substrate 270 are integrally formed. The substrate 270 is an annular part protruding from the end part of the stator 250 at the other side (the arrow b direction) in the axis direction, to the other side (the arrow d direction) in the radial direction. The substrate 270 is a flat plate-shaped insulating part. At the substrate 270, wiring and circuits not illustrated in the drawing are formed. In the motor 200, the electrical connection between the coil groups making up each phase, and the electrical connection between the coils belonging to the same phase are all achieved through the wiring and circuits formed at the substrate 270.

A plurality of (in the present embodiment, three) magnetic sensors 280 for detecting the magnetic pole position (rotation angle) of the rotor 260 is arranged at the surface (the surface at the side closer to the rotor 260) of the substrate 270 at one side (the arrow a direction) in the axis direction. In the axis direction, the magnetic sensor 280 is opposed to the rotor 260 (axial arrangement). In the present embodiment, the magnetic sensor 280 is a Hall IC, and is surface-mounted at the print wiring circuit of the substrate 270. In the present embodiment, the magnetic sensor 280 is a zero-cross detection type Hall IC that switches the output signal upon detecting a change in magnetic pole of the rotor 260 (switching from S-pole to N-pole, or from N-pole to S-pole). It should be noted that the magnetic sensor 280 may be another type of Hall IC, or may be a magnetic sensor other than a Hall IC.

The motor 200 has a configuration of 20 poles and 18 slots. Specifically, the stator 250 includes 18 teeth, and the rotor 260 includes 20 magnetic poles. Also in the motor 200, the magnetic sensors 280 are arranged to be opposed to the phase of the weakly energized phase or the non-energized phase at respective different predetermined electric angles. Specifically, when each magnetic sensor 280 detects a change in magnetic pole of the rotor 260, the phase located in the vicinity (e.g., the phase closest to the magnetic sensor 280 that detects a change in magnetic pole) is the non-energized phase, and thus the magnetic sensor 280 is less susceptible to the influence (disturbance) of the magnetic field generated by the stator 250.

The motor 200 according to the present embodiment also has the above-mentioned characteristics of the motor 100. In addition, in the motor 200 according to the present embodiment, the substrate 270 and the stator 250 are integrally formed. Accordingly, positioning between the substrate 270 and the stator 250 is not required, and the magnetic sensor 280 can be easily arranged. Accordingly, according to the motor 200, the control accuracy and motor efficiency are improved, and the number of components is reduced. In addition, in the motor 200, the electrical connections among all coils are achieved at the substrate 270, and it is therefore not necessary to ensure the space for crossover wire, thus achieving reduction in thickness.

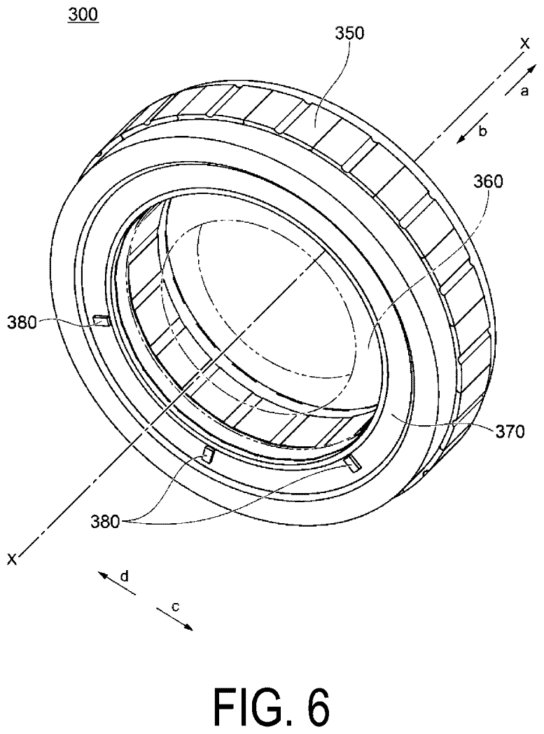

A motor 300 according to the embodiment illustrated in FIG. 6 includes a stator 350, a rotor 360 indicated by the virtual line, a substrate 370, and a magnetic sensor 380. In FIG. 6, the configurations other than the stator 350, the rotor 360, the substrate 370, and the magnetic sensor 380 in the motor 300 are omitted. The configurations of the omitted parts may be the same as or different from the configurations in the motor 100 or the motor 200.

At the inside (the other side, the arrow d direction) of the stator 350 in the radial direction, the rotor 360 is coaxially arranged to be opposed to the stator 350. The stator 350 and the rotor 360 have substantially the same configurations as the stator 150 and the rotor 160 of the motor 100 except for the number of poles and slots.

In the motor 300, the stator 350 and the substrate 370 are integrally formed. More specifically, the insulator of the stator 350 and the substrate 370 are integrally formed. In the axis direction, the substrate 370 is a part having an annular shape arranged in the vicinity of the end part of the stator 350 at the other side (the arrow b direction). The inner diameter of the substrate 370 is the same as or substantially the same as the inner diameter of the stator 350. The substrate 370 is a flat plate-shaped insulation part. Wiring or circuits not illustrated in the drawing are formed at the substrate 370. In the motor 300, the electrical connection between the coil groups making up each phase, and the electrical connection between the coils belonging to the same phase are all achieved through the wiring and circuits formed at the substrate 370.

In the axis direction, a plurality of (in the present embodiment, three) magnetic sensors 380 for detecting the magnetic pole position (rotation angle) of the rotor 360 is arranged at a surface (a surface at the side away from the rotor 260) of the substrate 370 at the other side (the arrow b direction). The magnetic sensor 380 is arranged to be opposed to the stator 350 in the axis direction at one side (the arrow c direction) of the rotor 360 in the radial direction (radial arrangement). In the present embodiment, the magnetic sensor 380 is a Hall IC, and is surface-mounted at the print wiring circuit of the substrate 370. In the present embodiment, the magnetic sensor 380 is a zero-cross detection type Hall IC that switches the output signal upon detecting a change in magnetic pole of the rotor 360 (switching from S-pole to N-pole, or from N-pole to S-pole). It should be noted that the magnetic sensor 380 may be another type of Hall IC, or may be a magnetic sensor other than a Hall IC. The magnetic sensor 380 may be arranged inside the structure of the integrally formed stator 350 and substrate 370. For example, the magnetic sensor 380 may be arranged inside the resin covering the stator 350 and the substrate 370.

The motor 300 has a configuration of 20 poles and 18 slots. Specifically, the stator 350 includes 18 teeth, and the rotor 360 includes 20 magnetic poles. Also in the motor 300, the magnetic sensors 380 are arranged at the phase of the weakly energized phase or the non-energized phase at respective different predetermined electric angles. Specifically, when each magnetic sensor 380 detects a change in magnetic pole of the rotor 360, the phase located in the vicinity (e.g., the phase closest to the magnetic sensor 380 that detects a change in magnetic pole) is the non-energized phase, and thus the magnetic sensor 380 is less susceptible to the influence (disturbance) of the magnetic field generated by the stator 350.

The motor 300 according to the present embodiment also has the above-mentioned characteristics of the motors 100 and 200. In addition, in the motor 300, the magnetic sensor 380 is arranged at the stator 350 side of the outer periphery part of the rotor 260 in the radial direction, and arranged to be opposed to the stator 350 in the axis direction. In the motor 300, since the magnetic sensor 380 is less susceptible to the influence of the magnetic field generated from the stator 350, the control accuracy and motor efficiency are excellent even in the radial arrangement. In addition, since the substrate 370 does not protrude to the inside (the other side, the arrow d direction) of the stator 350 in the radial direction, the insertion direction of the rotor 360 is not limited to one direction during assembly of the motor 300, and thus the flexibility in manufacturing is improved.

The motors 100, 200 and 300 according to the present embodiment are so-called radial type motors (radial gap motors), and include a rotor provided with a magnet. The motor 100, 200 and 300 include a structure that the energized phase includes a magnetic body including the magnetic pole part opposed to the rotor, and the first coil wound around the magnetic body, and a predetermined magnetic pole of the rotor is opposed to the magnetic pole part of the energized phase in the radial direction. However, the motor of the present invention is not limited to this, and may also be a so-called axial-type motor (axial gap motor). Specifically, in the motor of the present invention, a predetermined magnetic pole of the rotor may be opposed to the magnetic pole part of the energized phase in the axis direction.

In addition, the motor according to the present invention can be appropriately modified and the shapes, the dimensions, and the combinations of the various configurations can be modified, by a person skilled in the art according to previously known knowledge.

Such modifications are of course included in the scope of the present invention as long as these modifications still include the configurations of the present invention.

### REFERENCE SIGNS LIST

100, 200, 300 . . . Motor, 150, 250, 350 . . . Stator, 152 . . . Coil, 153 . . . Teeth (Magnetic pole part), 160, 260, 360 . . . Rotor, 161, 162 . . . Magnet, 163 . . . Rotor core (Magnetic body), 180, 280, 380 . . . Magnetic sensor

1. A motor comprising:
a stator including an energized phase, a phase energized more weakly than the energized phase or a non-energized phase at a predetermined electric angle; and
a magnetic sensor,
wherein the magnetic sensor is arranged to be opposed to the phase energized more weakly or the non-energized phase.

2. The motor according to claim 1, comprising a rotor including a magnet, wherein
the energized phase includes a magnetic body and a first coil wound around the magnetic body, the magnetic body including a magnetic pole part opposed to the rotor, and
a predetermined magnetic pole of the rotor is opposed to the magnetic pole part of the energized phase.

3. The motor according to claim 1, wherein
the phase energized more weakly or the non-energized phase includes one or a plurality of second coils, and
in a circumferential direction, the magnetic sensor is located at a position overlapping the second coil or a position between adjacent two second coils among the plurality of second coils.

4. The motor according to claim 1, further comprising a rotor including a magnetic body and a plurality of magnets arranged inside the magnetic body, wherein
the magnetic sensor detects a change in magnetic pole of the rotor.

5. The motor according to claim 4, wherein the magnetic sensor is opposed to the rotor in a rotation axis direction.
